(19) United States
(12) Patent Application Publication
(10) Pub. No.: US 2026/0295589 A1
(43) Pub. Date: Oct. 1, 2026

(54) MICROFLUIDIC DEVICES, MICROFLUIDIC SYSTEMS, AND METHODS FOR ASSESSING INTERACTION BETWEEN AN OIL COMPOSITION AND A SOLVENT

(71) Applicant: INTERFACE FLUIDICS LTD., CALGARY (CA)

(72) Inventors: ZAHRA BARIKBIN, EDMONTON (CA); SOURABH AHITAN, EDMONTON (CA); ALI ABEDINI, EDMONTON (CA)

(73) Assignee: INTERFACE FLUIDICS LTD., CALGARY, AB (CA)

(21) Appl. No.: 19/475,778

(22) PCT Filed: Apr. 16, 2024
(86) PCT No.: PCT/CA2024/050486

§ 371 Date: Oct. 16, 2025

Related U.S. Application Data
(60) Provisional application No. 63/498,282, filed on Apr. 26, 2023.

(51) Int. Cl. B01L 3/00

(52) U.S. Cl. CPC B01L 3/502784; B01L 2200/0673; B01L 2300/0816; B01L 2300/0883; B01L 2300/18; B01L 2400/0487

(57) ABSTRACT

A method for assessing interaction between an oil composition and a solvent includes: a. within a microfluidic channel, isolating at least a first compound slug in an isolation fluid, wherein the first compound slug comprises at least a first slug of an oil composition in contact with at least a first slug of a solvent; and b. with the first compound slug isolated in the isolation fluid and within the microfluidic channel, and while maintaining the microfluidic channel at a first test temperature and a first test pressure, conducting an optical investigation of at least the first compound slug to assess interaction between the oil composition and the solvent at the first test pressure and first test temperature.

### CROSS-REFERENCES TO RELATED APPLICATIONS

This application claims the benefit of and/or priority to U.S. Provisional Patent Application No. 63/498,282 filed on Apr. 26, 2023, which is incorporated herein by reference in its entirety.

### FIELD

This document relates to microfluidics. More specifically, this document relates to microfluidic devices such as microfluidic chips, systems including microfluidic devices, and methods for assessing interaction between an oil composition and a solvent.

### BACKGROUND

U.S. Pat. No. 8,485,026 (Mostowfi) discloses a method of measuring thermo-physical properties of a reservoir fluid. The method includes introducing the fluid under pressure into a microchannel, establishing a stabilized flow of the fluid through the microchannel, inducing bubble formation in the fluid disposed in the microchannel, and determining the thermo-physical properties of the fluid based upon the bubbles formed as the fluid flows through the microchannel.

U.S. Pat. No. 9,752,430 (Mostowfi et al.) discloses an apparatus for measuring phase behavior of a reservoir fluid. The apparatus includes a first sample container and a second sample container in fluid communication with a microfluidic device defining a microchannel. A first pump and a second pump are operably associated with the sample containers and the microfluidic device to fill the microchannel with a reservoir fluid and to maintain a predetermined pressure of reservoir fluid within the microchannel.

### SUMMARY

The following summary is intended to introduce the reader to various aspects of the detailed description, but not to define or delimit any invention.

Methods for assessing interaction between an oil composition and a solvent are disclosed.

According to some aspects, a method for assessing interaction between an oil composition and a solvent includes: a. within a microfluidic channel, isolating at least a first compound slug in an isolation fluid, wherein the first compound slug includes at least a first slug of an oil composition in contact with at least a first slug of a solvent; and b. with the first compound slug isolated in the isolation fluid and within the microfluidic channel, and while maintaining the microfluidic channel at a first test temperature and a first test pressure, conducting an optical investigation of at least the first compound slug to assess interaction between the oil composition and the solvent at the first test pressure and first test temperature.

In some examples, step b. is carried out while the first compound slug is maintained generally stationary within the microfluidic channel.

In some examples, step b. includes assessing a liquid phase volume and a gas phase volume for at least the first compound slug.

In some examples, the method further includes: prior to step b., assessing a ratio of the solvent to the oil composition for at least the first compound slug.

In some examples, the first compound slug is one of a plurality of compound slugs, step a. includes isolating each compound slug in the isolation fluid and within the microfluidic channel, and step b. includes conducting an optical investigation of each compound slug to assess the interaction between the oil composition and the solvent at the first test pressure and first test temperature. In some examples, the method further includes, prior to step b.: with each compound slug isolated in the isolation fluid and within the microfluidic channel, assessing a respective ratio of the solvent to the oil composition for each compound slug.

In some examples, the method further includes: c. adjusting the microfluidic channel to a subsequent test pressure; and d. after step c. and while maintaining the first compound slug at the subsequent test pressure, conducting another optical investigation of at least the first compound slug to assess interaction between the oil composition and the solvent at the subsequent test pressure. In some examples, steps b. and c. include using the isolation fluid as a piston fluid to maintain the microfluidic channel at the first test pressure and to adjust the microfluidic channel to the subsequent test pressure. In some examples, throughout steps b., c., and d., the first compound slug is maintained generally stationary within the microfluidic channel. In some examples, the method further includes serially repeating steps c. and d. with further subsequent test pressures until the first compound slug is of a single phase. In some examples, the method further includes serially repeating steps c. and d. with further subsequent test pressures to assess a saturation pressure for the oil composition and the solvent at the mole ratio and at the first test temperature. In some examples, the method further includes serially repeating steps c. and d. with further subsequent test pressures to assess an oil swelling factor for the oil composition and the solvent at the mole ratio and at the first test temperature. In some examples, the method further includes serially repeating steps c. and d. with further subsequent test pressures to assess at least one of a diffusivity and a solubility of the solvent in the oil composition and at the first test temperature. In some examples, the method further includes serially repeating steps c. and d. with further subsequent test pressures to assess a first contact minimum miscibility pressure for the solvent and the oil composition and at the first test temperature.

In some examples, the method further includes, prior to step a.: within the microfluidic channel, combining an oil and a gas to yield the first slug of the oil composition.

In some examples, step a. includes flowing the solvent into the microfluidic channel to fill the microfluidic channel with the solvent; while continuing to flow the solvent into the microfluidic channel, flowing the isolation fluid into the microfluidic channel, to form at least the first slug of the solvent in the isolation fluid; and while continuing to flow the solvent and the isolation fluid into the microfluidic channel, flowing the oil composition into the microfluidic channel, to form at least the first slug of the oil composition in the isolation fluid and yield the first compound slug.

In some examples, step a. includes: i. in a first branch of the microfluidic channel, forming at least the first slug of the solvent in the isolation fluid; ii. in a second branch of the microfluidic channel, forming at least the first slug of the oil composition in the isolation fluid; and after steps i., and ii., combining the first slug of the solvent and the first slug of the oil composition to yield the first compound slug. In some examples, step iii. includes flowing the first slug of the oil composition and the first slug of the solvent into a micropillar array of the microfluidic channel.

Microfluidic devices are also disclosed.

According to some aspects, a microfluidic device includes a microfluidic substrate, which includes a main inlet port, a main outlet port, and a main microfluidic channel extending between and in fluid communication with the main inlet port and the main outlet port. The microfluidic substrate further includes a solvent inlet port, a solvent outlet port, and a solvent bypass channel extending between and in fluid communication with the solvent inlet port and the solvent outlet port. The microfluidic substrate further includes a solvent feed channel extending between and in fluid communication with the solvent bypass channel and the main microfluidic channel. The solvent feed channel is joined to the main microfluidic channel at a first junction. The microfluidic substrate further includes an oil inlet port, an oil outlet port, and an oil bypass channel extending between and in fluid communication with the oil inlet port and the oil outlet port. The microfluidic substrate further includes an oil feed channel extending between and in fluid communication with the oil bypass channel and the main microfluidic channel. The oil feed channel is joined to the main microfluidic channel at a second junction. The second junction is spaced from the first junction.

In some examples, the first junction is in a first section of the main microfluidic channel, and the second junction is in a second section of the main microfluidic channel that is downstream of the first section.

In some examples, at least one of the first junction and the second junction is a T-junction.

In some examples, the oil feed channel includes a filter zone.

In some examples, the main microfluidic channel includes an enlargement at the first junction.

In some examples, the main microfluidic channel includes a first section downstream of the main inlet, where the first section branches into a first branch and a second branch that are in parallel and that join at a third junction. A second section may be downstream of the third junction. The first junction may be in the first branch and the second junction may be in the second branch. The main microfluidic channel may further include a third section between the third junction and the second section, and the third section may include a micropillar array.

In some examples, the solvent inlet port and the oil inlet port are in fluid communication only via the main microfluidic channel.

Microfluidic systems are also disclosed.

According to some aspects a microfluidic system includes a microfluidic device including a microfluidic substrate, where the microfluidic substrate includes a main microfluidic channel. The microfluidic system further includes an isolation fluid injection sub-system housing an isolation fluid and configured to force the isolation fluid into the main microfluidic channel. The microfluidic system further includes a solvent injection sub-system housing a solvent and configured to force the solvent into the main microfluidic channel concurrently with the isolation fluid to form at least a first slug of the solvent in the isolation fluid and within main microfluidic channel. The microfluidic system further includes an oil composition injection sub-system housing the oil composition and configured to force the oil composition into the main microfluidic channel concurrently with the isolation fluid and the solvent, to form at least a first compound slug in the isolation fluid and within the main microfluidic channel, where the first compound slug includes at least a first slug of the oil composition in contact with the first slug of the solvent. The microfluidic system further includes a pressure regulation sub-system for regulating pressure in the main microfluidic channel. The microfluidic system further includes a manifold providing fluid communication between the microfluidic device and the solvent injection sub-system, the isolation fluid injection sub-system, the oil composition injection sub-system, and the pressure regulation sub-system. The microfluidic system further includes a temperature regulation sub-system for regulating a temperature within the main microfluidic channel. The microfluidic system further includes an optical investigation sub-system for optically accessing at least a portion of the main microfluidic channel for assessment of at least the first compound slug.

In some examples, the microfluidic substrate further includes a main inlet port that is in fluid communication with the isolation fluid injection system via the manifold, and a main outlet port that is in fluid communication with the pressure regulation system via the manifold. The main microfluidic channel can extend between and be in fluid communication with the main inlet port and the main outlet port.

In some examples, the microfluidic substrate further includes a solvent inlet port that is in fluid communication with the solvent injection system via the manifold, a solvent outlet port that is in fluid communication with the pressure regulation system via the manifold, a solvent bypass channel extending between and in fluid communication with the solvent inlet port and the solvent outlet port, and a solvent feed channel extending between and in fluid communication with the solvent bypass channel and the main microfluidic channel.

In some examples, the microfluidic substrate further includes an oil inlet port that is in fluid communication with the oil composition injection system via the manifold, an oil outlet port that is in fluid communication with the pressure regulation system via the manifold, an oil bypass channel extending between and in fluid communication with the oil inlet port and the oil outlet port, and an oil feed channel extending between and in fluid communication with the oil bypass channel and the main microfluidic channel.

In some examples, the pressure regulation sub-system includes a back pressure pump in fluid communication with the main outlet port, the solvent outlet port, and the oil outlet port via the manifold. In some examples, the pressure regulation sub-system further includes a pressure bypass line system providing fluid communication between the isolation fluid injection sub-system and the main outlet port, external to the microfluidic device. The isolation fluid can be forced through the pressure bypass line system to pressurize the main microfluidic channel. In some examples, the pressure bypass line system further provides fluid communication between the isolation fluid injection sub-system and the oil inlet port, external to the microfluidic device. In some examples, the pressure bypass line system further provides fluid communication between the isolation fluid injection sub-system and the solvent outlet port, external to the microfluidic device. In some examples, the pressure bypass line system further provides fluid communication between the isolation fluid injection sub-system and the oil outlet port, external to the microfluidic device.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1A is a schematic view showing a first example of a compound slug isolated within an isolation fluid and within a microfluidic channel;

FIG. 1B is a schematic view showing a second example of a compound slug isolated within an isolation fluid and within a microfluidic channel;

FIG. 1C is a schematic view showing a third example of a compound slug isolated within an isolation fluid and within a microfluidic channel;

FIG. 1D is a schematic view showing a fourth example of a compound slug isolated within an isolation fluid and within a microfluidic channel;

FIG. 1E is a schematic view showing a plurality of compound slugs isolated within an isolation fluid and within a microfluidic channel;

FIG. 2 is a perspective view of an example microfluidic device;

FIG. 3 is a plan view of the microfluidic device of FIG. 2;

FIG. 4 is an enlarged view of the region encircled in dotted line in FIG. 3;

FIG. 5 is a schematic view of an example microfluidic system including the microfluidic device of FIGS. 2 to 4;

FIG. 6 is a flowchart showing an example method for assessing interaction between an oil composition and a solvent;

FIG. 7A is a plan view of another example microfluidic device;

FIG. 7B is an enlarged view of the region encircled in dotted line in FIG. 7A;

FIG. 8A is a plan view of another example microfluidic device;

FIG. 8B is an enlarged view of the region encircled in dotted line in FIG. 8A;

FIG. 8C is an enlarged view of the region encircled in dotted line in FIG. 8B;

FIG. 9A is a plan view of another example microfluidic device;

FIG. 9B is an enlarged view of region 9B encircled in dotted line in FIG. 9A; and

FIG. 9C is an enlarged view of region 9C encircled in dotted line in FIG. 9A.

### DETAILED DESCRIPTION

Various apparatuses or processes or systems or compositions will be described below to provide an example of an embodiment of the claimed subject matter. No embodiment described below limits any claim and any claim may cover processes or apparatuses or systems or compositions that differ from those described below. The claims are not limited to apparatuses or processes or systems or compositions having all of the features of any one apparatus or process or system or composition described below or to features common to multiple or all of the apparatuses or processes or systems or compositions described below. It is possible that an apparatus or process or system or composition described below is not an embodiment of any exclusive right granted by issuance of this patent application. Any subject matter described below and for which an exclusive right is not granted by issuance of this patent application may be the subject matter of another protective instrument, for example, a divisional patent application, and the applicants, inventors or owners do not intend to abandon, disclaim or dedicate to the public any such subject matter by its disclosure in this document.

In addition, numerous specific details are set forth in order to provide a thorough understanding of the subject matter disclosed herein. However, the subject matter disclosed herein may be practiced without these specific details. In other instances, well-known methods, procedures and components have not been described in detail so as not to obscure the subject matter disclosed herein. The description is not to be considered as limiting the scope of the subject matter disclosed herein.

Terms of degree such as “substantially”, “about”, and “approximately” as used herein mean a reasonable amount of deviation of the modified term such that the end result is not significantly changed. For example, the term “about” may indicate a degree of variability in a value or range of within 10%, within 5%, or within 1% of a stated value or of a stated limit of a range. These terms of degree may also be construed as including a deviation of the modified term if this deviation would not negate the meaning of the term it modifies.

Any recitation of numerical ranges by endpoints herein includes all numbers and fractions subsumed within that range, including the endpoints (e.g. 1 to 5 includes 1, 1.5, 2, 2.75, 3, 3.90, 4, and 5). It is also to be understood that all numbers and fractions thereof are presumed to be modified by the term “about”.

As used herein, the wording “and/or” is intended to represent an inclusive-or. That is, “X and/or Y” is intended to mean X or Y or both. As a further example, “X, Y, and/or Z” is intended to mean X or Y or Z or any combination thereof. Furthermore, the phase “at least one of A and B” is intended to mean only A (i.e. one or multiple of A), only B (i.e. one or multiple of B), or a combination of one or more of A and one or more of B.

As used herein, the term “assess” includes (but is not limited to) determination, estimation, calculation, quantification, modelling, prediction, analysis, testing, and study. For example, the statement that “microfluidic devices can be used to assess the swelling factor of an oil composition” indicates that microfluidic devices can be used to determine, to estimate, to calculate, to model, to predict, to analyze, to test, and/or to study the swelling factor of an oil composition.

As used herein, the term “study fluid” refers to any fluid(s) assessed by the devices, systems, and methods disclosed herein. Example study fluids include, but are not limited to, oil compositions, solvents, refrigerants, water methane blends, and/or consumer chemicals. While the examples described below relate to the use of oil compositions and solvents as a study fluids, other study fluids are usable in the devices, systems, and methods described below.

As used herein, the term “oil composition” refers to a composition that includes or is made up of an oil. An oil composition may be synthetic or naturally derived. An oil composition can be a crude oil, or a crude oil fraction (e.g. a portion of a crude oil that has been distilled or otherwise separated from the crude oil). An oil composition can be a sample that resembles (e.g. has a composition substantially similar to) a crude oil or a crude oil fraction. An oil composition can be a dead oil (i.e. an oil composition taken from a subterranean formation and that does not flash at ambient temperature and pressure) or a live oil (i.e. an oil composition taken from a subterranean formation and having dissolved gases that spontaneously evolve at ambient pressure and temperature). An oil composition can be a gas, a liquid, and/or a supercritical composition. An oil composition can be a single-component composition or a multi-component composition.

As used herein, the term “solvent” refers to a substance that dissolves in an oil composition. A solvent may be gaseous or liquid. A solvent may be a single-component substance, or a multi component substance. Example solvents include, but are not limited to, methane, carbon dioxide, nitrogen, and/or a blend of hydrocarbons (such as C1, C2, or C3 hydrocarbons).

As used herein, the term “isolation fluid” refers to a fluid that is substantially immiscible with one or more given study fluids, such as an oil composition and a solvent. The term “isolation fluid” can refer to a liquid, a gas, a supercritical fluid, or a combination thereof. The term “isolation fluid” can refer to a single-component fluid, or a mixture of different components. Example isolation fluids include, but are not limited to, water, liquid metals or alloys, and/or ionic fluids. Specific examples of isolation fluids include fluorinert, mercury, galinstan, fluorocarbon oil and/or polyethylene glycol.

As used herein, the term “oil swelling” refers to the expansion of an oil composition upon mixing with a solvent and dissolution of the solvent therein. Oil swelling may be due to the partial or complete dissolution of the solvent into the oil composition. The extent of swelling may be dependent on, for example, pressure, temperature, composition and physical properties of the solvent, and/or composition and physical properties of the oil composition.

As used herein, the term “oil swelling factor” refers to the ratio of the final volume of a slug of oil composition (after dissolution of a slug of solvent therein) to the initial volume of the slug of the oil composition (prior to the dissolution of the slug of solvent therein).

As used herein, the term “saturation pressure”, used with regards to a solvent and an oil composition together, refers to the minimum pressure at which all of the solvent is dissolved in the oil composition or vice-versa, for a given mole fraction of solvent and at a given temperature.

As used herein, the term “first contact minimum miscibility pressure” refers to the minimum pressure at which an oil composition and a solvent become miscible upon their first contact, in any proportion. In contrast, the term “multiple contact minimum miscibility pressure” refers to the minimum pressure at which an oil composition and a solvent become miscible upon multiple contacts.

As used herein, the term “diffusivity” refers to the rate of dissolution of a solvent in an oil composition, for example in m²/s.

As used herein, the term “solubility” refers to the amount of solvent (in mol or mass or volume) that dissolves in a specific amount (in mol or mass or volume) of an oil composition, for example in moles/L, mg/L or ppm.

As used herein, the term “interaction between an oil composition and a solvent” can refer to (but is not limited to) one or more of the following parameters of an oil composition and solvent: saturation pressure, first contact minimum miscibility pressure, diffusivity, solubility, volume (e.g. volume of a slug of an oil composition and a slug of solvent), ratio of one component to another (e.g. mass, mole, and/or volume ratio), and/or oil swelling factor.

As used herein, the term “microfluidic channel” refers to a narrow and elongate feature (e.g. having a length that is greater than its width, such as a length to width ratio of at least 10:1 or at least 25:1 or at least 50:1 or at least 100:1) of a microfluidic chip, through which substances (e.g. isolation fluids, oil compositions, and/or solvents) can flow. A microfluidic channel can be, for example, etched or drilled into a microfluidic chip. A microfluidic channel can be linear or non-linear (e.g. serpentine). A microfluidic channel can be of a constant depth, or can have multiple sections of different depths. A microfluidic channel can include a single section, or multiple sections. In examples in which a microfluidic channel includes multiple sections, the sections may be arranged in series, arranged in parallel, or some combination thereof. In examples in which a microfluidic chip includes multiple sections that are arranged in parallel, the microfluidic channel may be described as being “branched”.

Generally disclosed herein are microfluidic devices in the form of microfluidic chips, systems incorporating microfluidic devices, and related methods. The microfluidic devices, systems, and methods can be used to assess the interaction of study fluids, in particular the interaction between an oil composition and a solvent. For example, the microfluidic devices, systems, and methods can be used in the oil and gas industry, in order to predict behavior of oil compositions and solvents in oil-bearing subterranean formations (e.g. in shale and/or tight oil formations, as well as fracture zones (also known as “frac zones”) created in such formations during hydraulic fracturing).

For example, the microfluidic devices, systems, and methods can be used to assess oil swelling (e.g. to assess the oil swelling factor of an oil composition and a solvent), saturation pressure (e.g. to assess the saturation pressure of an oil composition and a solvent), volume (e.g. to assess the volume of an oil composition and the volume of a solvent), diffusivity (e.g. to assess the rate of dissolution of a solvent in an oil composition), solubility (e.g. to assess the amount of solvent in mol or mass that dissolves in an oil composition), and/or first contact minimum miscibility pressure (e.g. to assess the first contact minimum miscibility pressure of an oil composition and a solvent).

In general, the microfluidic devices, systems, and methods disclosed herein can in some examples allow for fast, inexpensive, and/or reliable assessment of the interaction between an oil composition and a solvent. For example, the oil swelling factor of an oil composition and solvent can be assessed in a matter of hours (as opposed to weeks), using only a small volume of oil composition and solvent (e.g. less than 10 mL), with minimal labor and cost. Furthermore, the devices, systems, and method disclosed herein can provide a relatively large data set, with relatively high accuracy. Furthermore, the systems and methods disclosed herein can be automated and precisely controlled, which can allow for accuracy as well as reduced costs and reduced manpower.

In general, the microfluidic devices disclosed herein can include a microfluidic channel (also referred to herein as a “main microfluidic channel”). As will be described in greater detail below, the microfluidic channel can be loaded such that it includes one or more compound slugs, and such that each compound slug is isolated within an isolation fluid.

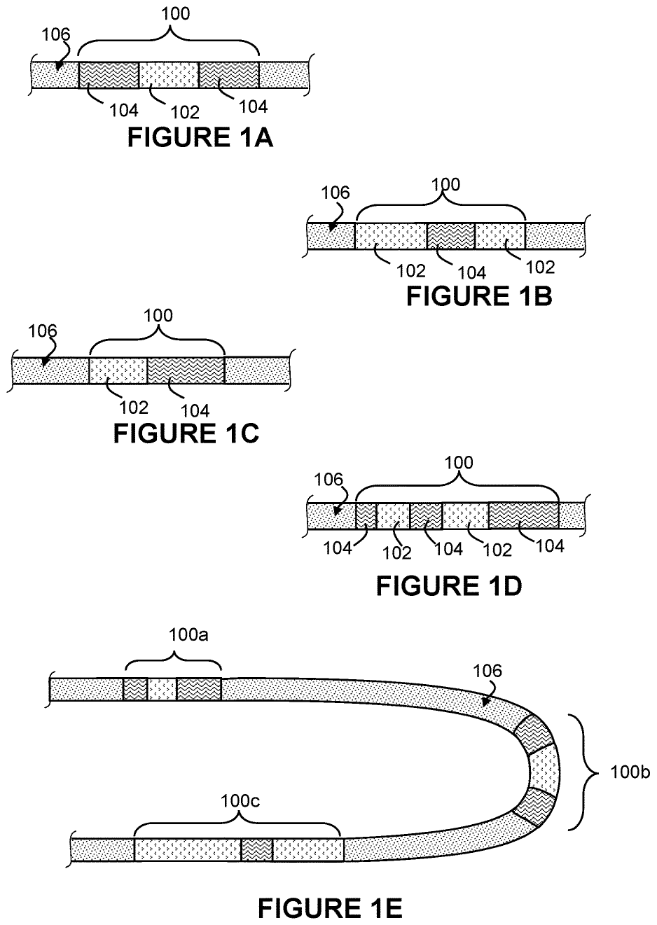

As used herein, the term “compound slug” refers to a structure that includes at least one slug of oil composition and at least one slug of solvent, where the slugs are in contact. For example, as shown in FIG. 1A, a compound slug 100 can include a slug of solvent 102 sandwiched between two slugs of oil composition 104 (i.e. a solvent-in-oil compound slug); as shown in FIG. 1B, a compound slug 100 can include a slug of oil composition 104 sandwiched between two slugs of solvent 102 (i.e. an oil-in-solvent compound slug); as shown in FIG. 1C, a compound slug 100 can a single slug of solvent 102 adjacent and in contact with a single slug of oil composition 104; as shown in FIG. 1D, a compound slug 100 can include multiple slugs of oil composition 104 interleaved with multiple slugs of solvent 102.

As can be seen in FIGS. 1A to 1D, each compound slug 100 is within a microfluidic channel and is isolated within an isolation fluid 106. As used herein, the term “isolated within an isolation fluid” indicates that a given compound slug 100 is bounded on opposite ends by isolation fluid 106, whether the isolation fluid 106 is a generally continuous phase or is itself in slug form.

In the methods described herein, a plurality of compound slugs are preferably loaded into a microfluidic channel and isolated within the isolation fluid 106 (e.g. between 10 and 100 compound slugs 100). For example, FIG. 1E shows a plurality of compound slugs 100a-100c that are within a microfluidic channel and isolated within the isolation fluid 106. However, the methods described herein may be carried out with only a single compound slug. That is, the devices, systems and methods described herein involve at least a first compound slug.

As will be described in greater detail below, with the microfluidic channel loaded with the compound slug(s) 100, while maintaining the compound slug(s) 100 generally stationary within the microfluidic channel, and while maintaining the microfluidic channel at a first test pressure and first test temperature (e.g. slightly above the saturation pressure for the oil composition at the first test temperature), an optical investigation can be conducted (for example with the use of a microscope, and either in real time or by analyzing a video recording or still images) to assess the interaction between the oil composition and the solvent. For example, an initial optical investigation can be conducted to determine the initial volume of solvent and initial volume of oil composition in each compound slug. This initial optical investigation can be carried out immediately after each compound slug(s) 100 is formed, prior to any substantial dissolution of the solvent in the oil composition. These values can be used to determine the ratio of solvent to oil composition for each compound slug 100 (where the ratio can be, but is not limited to, a volume ratio, a mass ratio, and/or a mole ratio). Another optical investigation can be carried out after steady state has been reached at the first test pressure and first test temperature (e.g. after the solvent fully or partially dissolves in the oil composition), to determine the final volume of solvent and volume of oil composition in each compound slug 100.

After steady state has been maintained for a period of time (e.g. between about 1 minute and about 60 minutes, such as about 5 minutes), the pressure can be adjusted (e.g. raised by between 0.1 and 100 bar, such as about 10 bar) to a subsequent test pressure. After steady state is again reached, another optical investigation can be conducted to assess the interaction between the oil composition and the solvent at the subsequent test pressure. For example, an optical investigation can be conducted to determine the volume of solvent and volume of oil composition in each compound slug 100 after steady state is reached (e.g. after the solvent fully or partially dissolves in the oil composition) at the subsequent test pressure. If the solvent fully dissolves in the oil composition for a given compound slug 100 at the subsequent test pressure, the saturation pressure and oil swelling factor can be assessed for the oil composition and solvent at the ratio of solvent to oil composition for the given compound slug 100. Again, this can be done for each compound slug 100 within the microfluidic channel (each of which may have a different ratio of solvent to oil composition).

The cycle of adjusting the pressure and conducting an optical investigation once steady state has been reached can be repeated until no further changes are seen in the microfluidic channel (e.g. until for each compound slug 100, the solvent is fully dissolved in the oil composition). Using the data collected at each test pressure, various additional parameters can be assessed. For example, a swell test plot can be generated for the solvent and oil composition (i.e. a plot of oil swelling factor versus ratio), the first contact minimum miscibility pressure can be assessed, and a swelling curve can be plotted.

Notably, in some examples of the methods described herein, after the compound slug(s) 100 is/are loaded into the microfluidic channel, the compound slug(s) 100 remain(s) generally stationary within the microfluidic channel over the remainder of the method. That is, while the compound slug(s) 100 may move somewhat within the microfluidic channel, the compound slug(s) 100 generally do not pass entirely through and exit the microfluidic channel while the pressure is adjusted, while steady state is reached, and while any real time steps of optical investigation are conducted. Instead, while the pressure is adjusted and equilibrium is reached, the microfluidic channel is generally closed to mass transfer, and the compound slug(s) 100 generally remain in the microfluidic channel and bounded by the isolation fluid.

Notably, in some examples, multiple compound slugs 100, each having a different ratio of solvent to oil composition, can be assessed in a single microfluidic channel at one time.

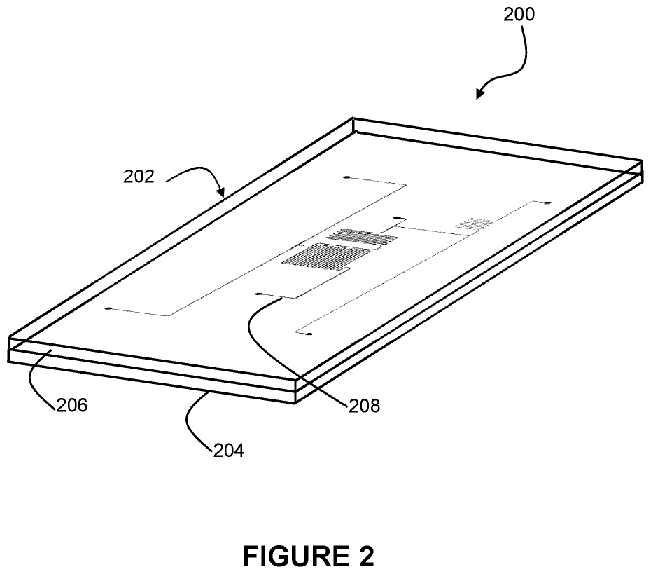

Referring now to FIG. 2, an example microfluidic device 200 is shown. The microfluidic device 200 may also be referred to as a “microfluidic chip”. The microfluidic device 200 includes a microfluidic substrate 202 that has various microfluidic features therein (i.e. channels and ports, described in further detail below). The microfluidic substrate 202 allows for optical investigation (e.g. imaging, optionally with the use of an optical microscope and/or video recording equipment and/or a photographic camera) of at least some of the microfluidic features.

Referring still to FIG. 2, in the example shown, the microfluidic substrate 202 includes a base panel 204 in which the microfluidic features are etched, and a cover panel 206 that is secured to the base panel 204 and that covers the microfluidic features. In the example shown, the base panel 204 is an opaque silicon panel, and the cover panel 206 is a transparent glass panel. In alternative examples, the microfluidic substrate 202 may be of another configuration. For example, both the base panel 204 and the cover panel 206 can be a transparent glass panel, or the base panel 204 can be a transparent glass panel while the cover panel 206 can be an opaque silicon panel.

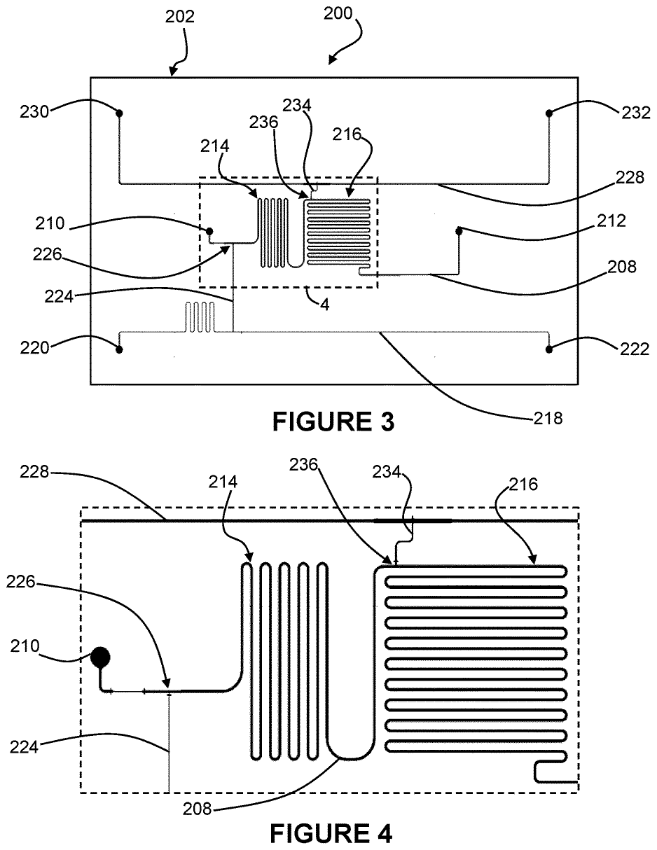

Referring also to FIGS. 3 and 4, the microfluidic substrate 202 includes a main microfluidic channel 208, as mentioned above. The main microfluidic channel 208 extends between and is in fluid communication with a main inlet port 210 and a main outlet port 212. The main microfluidic channel 208 has a length that is defined between the main inlet port 210 and the main outlet port 212. The length can be, for example, between about 1.9 cm and about 100 cm (e.g. about 16 cm). The main microfluidic channel 208 further has a width that can be, for example, between about 2 microns and about 200 microns (e.g. about 50 microns). Furthermore, the main microfluidic channel 208 has a depth that can be, for example, between about 0.1 microns and about 200 microns (e.g. about 50 microns). The width and/or depth can be constant along the length of the main microfluidic channel 208, or can vary.

Referring still to FIGS. 3 and 4, in the example shown, the main microfluidic channel 208 includes two sections (i.e. a first section 214 and a second section 216). The first section 214 and the second section 216 are arranged in series, with the second section 216 downstream of the first section 214 (going in the direction from the main inlet port 210 to the main outlet port 212). Each section 214, 216 is of a serpentine configuration. In alternative examples, the main microfluidic channel 208 can include another number of sections (e.g. only one section or more than two sections), and can be of another configuration (e.g. can extend linearly).

Referring still to FIGS. 3 and 4, the microfluidic substrate 202 further includes a solvent bypass channel 218, which extends between and is in fluid communication with a solvent inlet port 220 and a solvent outlet port 222. In the example shown, the solvent bypass channel 218 is generally linear, but includes a serpentine section. In alternative examples, the solvent bypass channel 218 may be of another configuration. The solvent bypass channel has a length that is defined between the solvent inlet port 220 and the solvent outlet port 222. The length can be, for example, between about 3.3 cm and about 95 cm (e.g. about 5.2 c,). The solvent bypass channel 218 further has a width that can be, for example, between about 2 microns and about 200 microns (e.g. about 15 microns). Furthermore, the solvent bypass channel 218 has a depth that can be, for example, between about 0.5 microns and about 3 microns (e.g. about 1 micron). The width and/or depth can be constant along the length of the solvent bypass channel 218, or can vary. The width and/or depth of the solvent bypass channel 218 can be the same as that of the main microfluidic channel 208, or different from that of the main microfluidic channel 208.

Referring still to FIGS. 3 and 4, the microfluidic substrate 202 further includes a solvent feed channel 224, which extends between and is in fluid communication with the solvent bypass channel 218 and the main microfluidic channel 208. The solvent feed channel 224 is joined to the main microfluidic channel 208 at a first junction 226, which is in the first section 214 of the main microfluidic channel. In the example shown, the first junction 226 is a T-junction. The solvent feed channel 224 has a length that is defined between the solvent bypass channel 218 and the main microfluidic channel 208. The length can be, for example, between about 0.01 cm and about 1.65 or 95 cm (e.g. about 0.3 cm). The solvent feed channel 224 further has a width that can be, for example, between about 2 microns and about 200 microns (e.g. about 15 microns). Furthermore, the solvent feed channel 224 has a depth that can be, for example, between about 0.1 microns and about 200 microns (e.g. about 1 micron). The width and/or depth can be constant along the length of the solvent feed channel 224, or can vary. The width and/or depth of the solvent feed channel 224 can be the same as that of the main microfluidic channel 208, or different from that of the main microfluidic channel 208.

Referring still to FIGS. 3 and 4, the microfluidic substrate 202 further includes an oil bypass channel 228, which extends between and is in fluid communication with an oil inlet port 230 and an oil outlet port 232. In the example shown, the oil bypass channel 228 is generally linear. In alternative examples, the oil bypass channel 228 may be of another configuration. The oil bypass channel 228 has a length that is defined between the oil inlet port 230 and the oil outlet port 232. The length can be, for example, between about 3.3 cm and about 95 cm (e.g. about 4.3 cm). The oil bypass channel 228 further has a width that can be, for example, between about 2 microns and about 200 microns (e.g. about 50 microns). Furthermore, the oil bypass channel 228 has a depth that can be, for example, between about 0.1 microns and about 200 microns (e.g. about 50 microns). The width and/or depth can be constant along the length of the oil bypass channel 228, or can vary. The width and/or depth of the oil bypass channel 228 can be the same as that of the main microfluidic channel 208, or different from that of the main microfluidic channel 208.

Referring still to FIGS. 3 and 4, the microfluidic substrate 202 further includes an oil feed channel 234, which extends between and is in fluid communication with the oil bypass channel 228 and the main microfluidic channel 208. The oil feed 234 channel is joined to the main microfluidic channel 208 at a second junction 236. In the example shown, the second junction 236 is spaced from (i.e. downstream of) the first junction 226, and is in the second section 216 of the main microfluidic channel 208. In the example shown, the second junction 236 is a T-junction. The oil feed channel 234 has a length that is defined between the oil bypass channel 228 and the main microfluidic channel 208. The length can be, for example, between about 0.01 cm and about 95 cm (e.g. about 0.15 cm). The oil feed channel 234 further has a width that can be, for example, between about 2 microns and about 200 microns (e.g. about 30 microns). Furthermore, the oil feed channel 234 has a depth that can be, for example, between about 0.1 microns and about 200 microns (e.g. about 1 microns). The width and/or depth can be constant along the length of the oil feed channel 234, or can vary. The width and/or depth of the oil feed channel 234 can be the same as that of the main microfluidic channel 208, or different from that of the main microfluidic channel.

As can be seen in FIG. 3, in the example shown, the solvent inlet port 220 and the oil inlet port 230 are in fluid communication only via the main microfluidic channel 208. That is, in the example shown, there is no on-chip bypass between the solvent inlet port 220 and the oil inlet port 230.

The terms used herein to describe the features of the microfluidic substrate 202 (e.g. “solvent inlet port”, “oil outlet port”, “oil feed channel”, etc.) are used for clarity and simplicity, and are not intended to limit the use of these ports and channels. For example, while the solvent inlet port 220 may in many examples be used to load a solvent into the microfluidic device 200, it may in other examples be used to load other materials (such as an isolation fluid and/or an oil composition), or may be used for egress of materials from the microfluidic device 200.

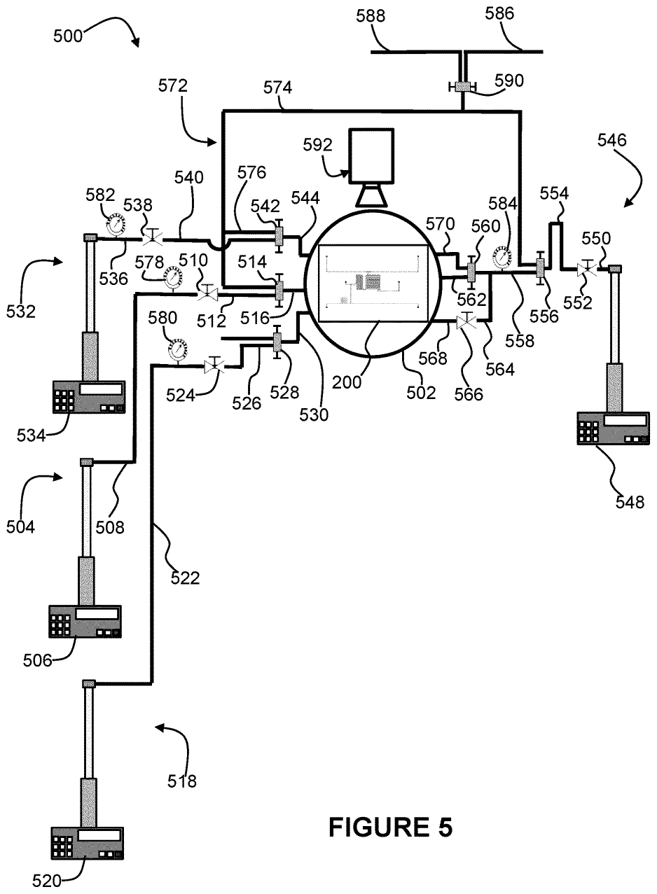

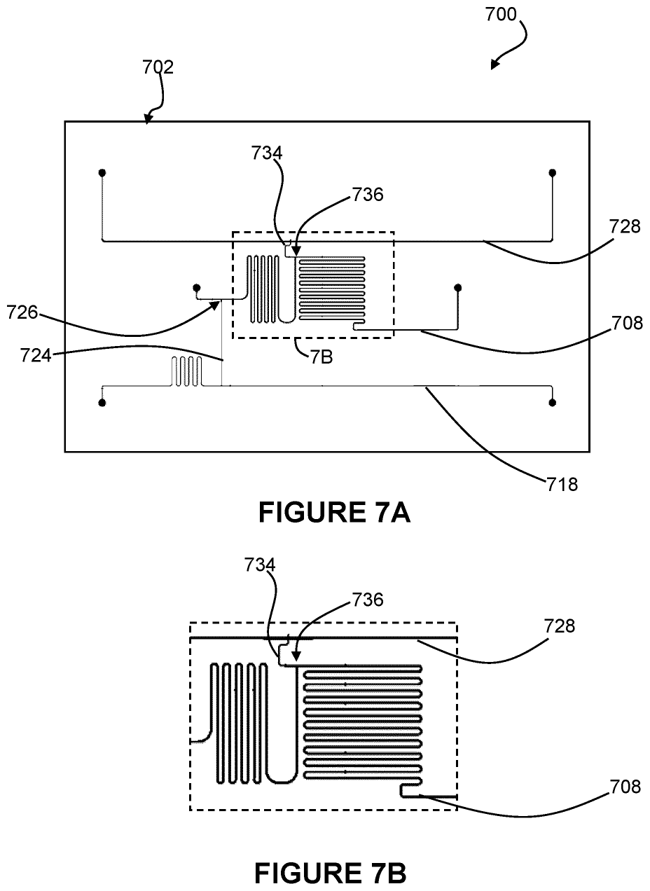

Referring now to FIG. 5, an example microfluidic system 500 is shown. As shown, the microfluidic system 500 includes the microfluidic device 200 of FIGS. 2 to 4; however, in alternative examples, the microfluidic system 500 can include various other microfluidic devices, such as those described below with regards to FIGS. 7 to 9. Furthermore, the microfluidic device 200 can be used in various other microfluidic systems.

Referring still to FIG. 5, in the example shown, the microfluidic device 200 is supported by a manifold 502 (which can also be referred to as a “holder”, and which is shown schematically in FIG. 5). The manifold 502 supports the microfluidic device 200, helps to distribute pressures across the microfluidic device 200, helps to heat or cool the microfluidic device 200, and provides for fluid communication between other parts of the system 500 (i.e. an isolation fluid injection sub-system, a solvent injection sub-system, an oil composition injection sub-system, and a pressure regulation sub-system, as described below) and the microfluidic device 200. The manifold 502 is not described in detail herein, and can be any suitable manifold. Examples of suitable manifolds are described in US patent application publication nos. 2021/0162421 (de Haas et al.) and 2021/0339258 (de Haas et al.); International Patent Application Publication No. WO 2022/251951 (de Haas et al.); and International Patent Application No. PCT/CA2023/051296 (de Haas et al.). Each of the aforementioned documents is incorporated herein by reference in its entirety.

Referring still to FIG. 5, the microfluidic system 500 further includes an isolation fluid injection sub-system 504, which is in fluid communication with the main inlet port 210 of the microfluidic device 200 via the manifold 502 (the features of the microfluidic device 200 are labelled in FIGS. 3 and 4, and are not labelled in FIG. 5). The isolation fluid injection sub-system 504 houses an isolation fluid and is configured to force the isolation fluid into the main microfluidic channel 208 of the microfluidic device 200. In the example shown, the isolation fluid injection sub-system 504 includes a first pump 506 that is in fluid communication with the main inlet port 210 of the microfluidic device 200 via line 508, valve 510, line 512, two-way valve 514, line 516, and manifold 502.

Referring still to FIG. 5, the microfluidic system 500 further includes a solvent injection sub-system 518 that is in fluid communication with solvent inlet port 220 of the microfluidic device 200 via the manifold 502. The solvent injection sub-system 518 houses a solvent, and as will be described in further detail below, is configured to force the solvent into the main microfluidic channel 208 concurrently with the isolation fluid, to form at least a first slug of the solvent in the isolation fluid and within main microfluidic channel 208. In the example shown, the isolation fluid injection sub-system 518 includes a second pump 520 that is in fluid communication with the solvent inlet port 220 of the microfluidic device 200 via line 522, valve 524, line 526, two-way valve 528, line 530, and the manifold 502.

Referring still to FIG. 5, the microfluidic system 500 further includes an oil composition injection sub-system 532 that is in fluid communication with the oil inlet port 230 of the microfluidic device 200 via the manifold 502. The oil composition injection sub-system 532 houses an oil composition, and as will be described in further detail below, is configured to force the oil composition into the main microfluidic channel 208 concurrently with the isolation fluid and the solvent, to form at least a first compound slug that is isolated in the isolation fluid and within the main microfluidic channel 208. In the example shown, the oil composition injection sub-system 532 includes a third pump 534 that is in fluid communication with the oil inlet port 230 of the microfluidic device 200 via line 536, valve 538, line 540, two-way valve 542, line 544, and the manifold 502.

Referring still to FIG. 5, the microfluidic system 500 further includes a pressure regulation sub-system 546, for regulating the pressure within the microfluidic device 200 (in particular, for regulating the pressure within the main microfluidic channel 208). In the example shown, the pressure regulation sub-system 546 includes a backpressure regulator in the form of a fourth pump 548 (also referred to herein as a backpressure pump). The fourth pump 548 is in fluid communication with main outlet port 210 via line 550, valve 552, line 554, two-way valve 556, line 558, two-way valve 560, line 562 and the manifold 502. The fourth pump 548 is further in fluid communication the solvent outlet port 222 via line 550, valve 552, line 554, two-way valve 556, line 558, line 564, valve 566, and line 568. The fourth pump 548 is further in fluid communication with the oil outlet port 232 via line 550, valve 552, line 554, two way valve 556, line 558, two way valve 560, and line 570.

The pressure regulation sub-system 546 further includes a pressure bypass line system 572. As will be described in further detail below, the pressure bypass line system 572 allows for the main microfluidic channel 208 to be pressurized by forcing the isolation fluid through the pressure bypass line system 572. In the example shown, the pressure bypass line system 572 provides fluid communication between the isolation fluid injection sub-system 504 and the main outlet port 212, external to the microfluidic device 200; provides fluid communication between the isolation fluid injection sub-system 504 and the oil inlet port 230, external to the microfluidic device 200; and provides fluid communication between the isolation fluid injection sub-system 504 and the solvent outlet port 222, external to the microfluidic device 200. In particular, in the example shown, the pressure bypass line system 572 includes a first bypass line 574 that extends between two-way valve 556 and two-way valve 514. The pressure bypass line system 572 further includes a second bypass line 576, which connects the first bypass line to two-way valve 542.

The pressure regulation sub-system 546 further includes a first pressure transducer 578 for monitoring the pressure in line 508, a second pressure transducer 580 for monitoring the pressure in line 522, a third pressure transducer 582 for monitoring the pressure in line 536, and a fourth pressure transducer 584 for monitoring the pressure in line 558.

The microfluidic system further includes a vacuum/purge line 586 and a nitrogen line 588, both of which are connected to the first bypass line 574 via two-way valve 590.

The microfluidic system further includes a temperature regulation sub-system (not shown), for regulating the temperature of at least the microfluidic device 200 (in particular, for regulating the temperature in the microfluidic channel 208). The temperature regulation sub-system may include various heaters (e.g. heating jackets), and various temperature transducers. In alternative examples, the temperature regulation sub-system can be configured to cool microfluidic device 200 and/or other parts of the system.

The microfluidic system 500 further includes include an optical investigation sub-system 592, for optically accessing the main microfluidic channel 208 (i.e. the entirety of the main microfluidic channel 208 or a portion thereof), and optionally other features of the microfluidic device 200. The optical investigation sub-system 592 can be used for assessment of the compound slug(s), as will be described in further detail below. The optical investigation sub-system can include, for example, one or more microscopes having a viewing window in which all or a portion of the microfluidic channel 208 can sit, one or more laser analysis systems, one or more photodiode analysis systems, one or more video cameras, and/or one or more still image cameras. The optical investigation sub-system 592 can be computerized and can further include image processing software and image analysis software. The image processing software can optionally automatically process images captured by the optical investigation sub-system, and the image analysis software can optionally automatically analyze images the processed images.

The microfluidic system 500 can further include a control sub-system (not shown) connected to one or more of the isolation fluid injection sub-system 504, the solvent injection sub-system 518, the oil composition injection sub-system 532, the pressure regulation sub-system 546, the temperature regulation sub-system, and the optical investigation sub-system 592. The control sub-system can include one or more processors, which can receive, process, and/or store information received from the other sub-systems to which it is connected. For example, the control system can receive temperature information from the temperature regulation subsystem, and pressure information from the pressure transducers 578-584. Furthermore, the control sub-system can send instructions to the isolation fluid injection sub-system 504, the solvent injection sub-system 518, the oil composition injection sub-system 532, the pressure regulation sub-system 546, the temperature regulation sub-system, and/or the optical investigation sub-system 592. For example, the control system can instruct the temperature regulation sub-system to increase and/or decrease the output of one or more heaters. The control sub-system can optionally provide automatic control of the microfluidic system 500. For example, the control sub-system can be configured to automatically instruct the temperature regulation sub-system to increase and/or decrease the output of one or more heaters, based on the received temperature information. The control sub-system can provide similar instructions to the pressure regulation sub-system 546.

It is to be understood that various parts of system 500 may be included in one or more of the subsystems of system 500. For example, valve 514 is part of the oil composition injection sub-system 532 and part of the pressure regulation sub-system 546.

Methods of assessing interaction between an oil composition and a solvent will now be described. The methods will be described with reference to the microfluidic device 200 and the microfluidic system 500; however, the methods are not limited to the microfluidic device 200 and the microfluidic system 500, and the microfluidic device 200 and microfluidic system 500 are not limited to operation in accordance with the methods. Furthermore, for clarity, the methods will be described with reference to a certain sequence of steps (e.g. a given step may be described as “a first step” or “a second step”, or terms such as “then” or “next” may be used); however, unless expressly indicated as such in the claims, the methods are not limited to any particular sequence of steps.

In general, the methods can include isolating at least a first compound slug 100 (shown in FIGS. 1A-1E) in an isolation fluid 106 (shown in FIGS. 1A to 1E) and within the main microfluidic channel 208 (shown in FIGS. 3 and 4). Preferably, a plurality of compound slugs 100, each having a different ratio of solvent to oil composition, are isolated in the isolation fluid 106 and within the microfluidic channel 208. With the compound slug(s) 100 isolated in the isolation fluid 106 and within the microfluidic channel 208, and while maintaining the microfluidic channel 208 at a first test temperature and a first test pressure, an optical investigation of the compound slug(s) 100 is conducted. Preferably, the pressure and/or temperature in the microfluidic channel 208 is then adjusted, and after reaching steady state, another optical investigation is conducted. This is preferably repeated several times at different pressures and/or temperatures, to assess interaction between the oil composition and the solvent (e.g. to assess the liquid phase volume and gas phase volume for the compound slug(s) 100; to asses a ratio of the solvent to the oil composition for the compound slug(s) 100; to assess a saturation pressure for the oil composition and the solvent; to assess an oil swelling factor for the oil composition and the solvent; to assess diffusivity of the solvent in the oil composition; to assess solubility of the solvent in the oil composition; to assess a first contact minimum miscibility pressure for the solvent and the oil composition; to plot a swelling curve and/or to generate a swell test plot for the solvent and the oil composition).

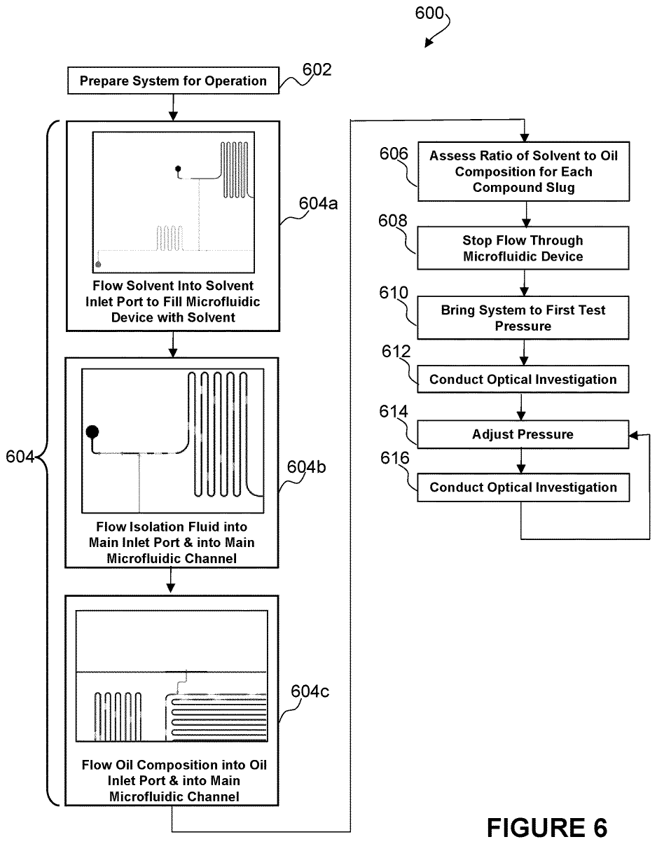

More specifically, an example method 600 for assessing interaction between an oil composition and a solvent is shown in FIG. 6. Reference will also be made to FIGS. 1A to 5.

At the start of the method, at step , the system 500 can be prepared for operation. For example, the system 500 can be configured as shown in FIG. 5. Furthermore, the temperature regulation sub-system can be engaged, to heat the various parts of system 500 (i.e. various lines, the manifold 502, and the microfluidic device 200, including the various channels) to a first test temperature. The first test temperature can be, for example, between about 0 degrees C and about 200 degrees C (e.g. about 75 degrees C). Furthermore the microfluidic chip 200 can be vacuumed via valve 590 and line 586, and then all valves can be closed.

At step 604, at least a first compound slug 100 (and preferably a plurality of compound slugs 100) can be isolated in the isolation fluid and within the main microfluidic channel 208. In general, this can be done by flowing the solvent into the main microfluidic channel 208 to fill the microfluidic channel 208 with the solvent; while continuing to flow the solvent into the main microfluidic channel 208, flowing the isolation fluid into the main microfluidic channel 208, to form at least a first slug of the solvent in the isolation fluid; and, while continuing to flow the solvent and the isolation fluid into the main microfluidic channel 208, flowing the oil composition into main the microfluidic channel 208, to form at least a first slug of the oil composition in the isolation fluid and yield the first compound slug. More specifically, the second pump 520 can be engaged, and valve 524 and two way valve 528 (bottom port) can be opened, to cause the solvent to flow into the solvent inlet port 220 of the microfluidic device 200, and begin to fill the solvent bypass channel 218, the solvent feed channel 224, the main microfluidic channel 208, the oil feed channel 234, and the oil bypass channel 228 with the solvent (step 604a). Then, with pump 520 still engaged and valve 524 and two-way valve 528 (bottom port) still open, the first pump 506 can be engaged and valves 510 and two way valve 514 (bottom port) can be opened, to cause the isolation fluid to flow into the main inlet port 210 and into the main microfluidic channel 208 of the microfluidic device 200, while solvent is still flowing into the microfluidic device 200 (step 604b). As the isolation fluid flows past the first junction 226, slugs of solvent will form in the stream of isolation fluid (as shown in FIG. 6). Then, with the solvent and isolation fluid still flowing into the microfluidic device 200, the oil composition can be forced into the main microfluidic channel 208. This can be done by engaging the third pump 534 and opening valve 538 and two-way valve 542 (bottom port), to cause the oil composition to flow into the oil inlet port 230 of the microfluidic device 200. At this point, valve 560 (top port) can be opened briefly, to direct flow of the oil composition out of the microfluidic device 200 via the oil outlet port 232, to fill the oil bypass channel 228 with oil composition and help to ensure that the microfluidic chip 200 contains a representative sample of oil composition. Two-way valve 560 (top port) can then be closed. Then, two-way valve 560 (bottom port), two way valve 556 (bottom port), and valve 552 can be opened, and fourth pump 548 can be engaged, to allow all three fluids to flow out of the microfluidic device 200 via the main outlet port 212, while applying backpressure (step 604c). With the system 500 in this configuration, the oil composition will flow from the oil bypass channel 228 into the oil feed channel 234, and from the oil feed channel 234 into the main microfluidic channel 208 via the second junction 236. As the oil composition flows through the second junction 236, slugs of oil composition will form in the stream of isolation fluid and solvent already flowing through the main microfluidic channel 208. Due to wetting properties of the oil composition and solvent, compound slugs 100 of oil composition and solvent will form within the main microfluidic channel 208.

As each compound slug forms, a ratio of solvent to oil composition for each compound slug can be assessed (e.g. a volume ratio, a mass ratio, and/or a mole ratio)(step 606). This can be done by conducting a preliminary optical investigation immediately after the formation of each compound slug (i.e. prior to any substantial dissolution of the solvent in the oil composition). For example, the optical investigation can include obtaining images of each compound slug, and analyzing the images to determine the ratio of each compound slug. All or a portion of step 606 can be carried out in real time. For example, images or a video recording can be captured in real time. Then, the analysis of the images or video recording can either be carried out in real time, or can be carried out at a later time. Optionally, step 606 can be at least partially automated. For example, as mentioned above, the control system can include image processing and analysis software that can assess the ratio of each compound slug.

Next, flow through the microfluidic device can be stopped, to maintain the compound slugs generally stationary within the main microfluidic channel (step 608). In particular, the pressure from fourth pump 548 can be increased until flow through the microfluidic device stops.

Next, the system can be brought to a first test pressure (step 610). This may be achieved using the isolation fluid as a piston fluid. In particular, valves 514 (top port) and 556 (top port) may be opened, to connect the main inlet port and the main outlet port in fluid communication via the bypass line system 572. Furthermore, valve 542 (bottom port) may be closed and valve 560 (top port) may be opened, to stop the flow of oil composition and place the oil bypass channel 228 in fluid communication with the pressure bypass line system 572. Furthermore, pump 520 may be disengaged and valve 566 may be opened, to stop the flow of solvent and place the solvent bypass channel 218 in fluid communication with the pressure bypass line system 572. Furthermore, valve 556 (bottom port) may be closed. With the system in this configuration, the pressure applied by pump 506 may be decreased to bring the main microfluidic channel to the first test pressure, using the isolation fluid as a piston fluid. The first test pressure can be, for example, be close to the saturation pressure of the oil composition alone (for example between 78 bar and 83 bar, such as 80 bar)

After steady state has been reached at the first test pressure, an optical investigation can be conducted (Step 612). In particular, with the compound slugs isolated in the isolation fluid and within the main microfluidic channel 208, while maintaining the compound slugs generally stationary within the main microfluidic channel 208, and while maintaining the main microfluidic channel 208 at the first test temperature and the first test pressure, an optical investigation can be conducted. Preferably, an optical investigation of each compound slug is conducted, to assess interaction between the oil composition and the solvent at the first test pressure and first test temperature, and at the ratio of each compound slug. For example, the optical investigation can include obtaining images of each compound slug, and analyzing the images to assess an oil composition volume and solvent volume of each compound slug (e.g. a liquid phase volume and a gas phase volume for each compound slug). All or a portion of step 612 can be carried out in real time. For example, images or a video recording can be captured in real time. Then, the analysis of the images or video recording can either be carried out in real time, or can be carried out at a later time. Optionally, step 612 can be at least partially automated. For example, as mentioned above, the control system can include image processing and analysis software that can assess the ratio of each compound slug.

Next, the microfluidic channel can be adjusted to a subsequent test pressure (step 614). This can be achieved by again using the isolation fluid as a piston fluid, and adjusting the pressure in the microfluidic channel using pump 506. The pressure can be adjusted (e.g. increased or decreased) in increments of, for example, between 0.5 bar and about 25 bar (e.g. about 2.5 bar, or about 5 bar, or about 10 bar).

After steady state has been reached at the subsequent test pressure (e.g. after between 5 minutes and about 10 minutes, such as about 5 minutes), another optical investigation can be conducted (Step 616). In particular, with the compound slugs isolated in the isolation fluid and within the main microfluidic channel 208, while maintaining the compound slugs generally stationary within the main microfluidic channel 208, and while maintaining the main microfluidic channel 208 at the first test temperature and the subsequent test pressure, another optical investigation can be conducted. Again, preferably, an optical investigation of each compound slug is conducted, to assess interaction between the oil composition and the solvent at the first test temperature, the subsequent test pressure, and at the ratio of each compound slug. For example, the optical investigation can include obtaining images of each compound slug, and analyzing the images to assess an oil composition volume and solvent volume of each compound slug (e.g. a liquid phase volume and a gas phase volume for each compound slug). All or a portion of step 616 can be carried out in real time. For example, images or a video recording can be captured in real time. Then, the analysis of the images or video recording can either be carried out in real time, or can be carried out at a later time. Optionally, step 616 can be at least partially automated. For example, as mentioned above, the control system can include image processing and analysis software that can assess the ratio of each compound slug.

Steps 614 and 616 can then be serially repeated with further subsequent test pressures. For example, steps 614 and 616 can be repeated until each compound slug is of a single phase. This can allow, for example, for the saturation pressure of the oil composition and the solvent to be assessed at the first test temperature and at each ratio; for the oil swelling factor for the oil composition and the solvent to be assessed at the first test temperature and at each ratio; for the diffusivity and/or a solubility of the solvent in the oil composition to be assessed at the first test temperature, at each ratio, and at each test pressure; and/or for the first contact minimum miscibility pressure of the oil composition and the solvent to be assessed at the first test temperature.

The above-described method describes adjusting the test pressure while holding the test temperature constant; however, in alternative examples, the test temperature may be adjusted while holding the test pressure constant.

The above-described method involves isolating a plurality of compound slugs in the isolation fluid and within the main microfluidic channel 208, and conducting an optical investigation of each compound slug. However, as mentioned above, in alternative examples, the method may be carried out with only a single compound slug. In other words, the method may involve isolating at least a first compound slug in the isolation fluid and within the main microfluidic channel 208, and conducting an optical investigation of at least the first compound slug.

Referring now to FIGS. 7A and 7B, a further example of a microfluidic device is shown. Features in FIGS. 7A and 7B that are like those of FIGS. 2 to 4 will be referred to with like reference numerals as in FIGS. 2 to 4, incremented by 500. The microfluidic device 700 of FIGS. 7A and 7B may be used in the system 500 of FIG. 5, or in other systems. The microfluidic device 700 may be used according to the methods described above and shown in FIG. 6, or according to other methods.

Similarly to the microfluidic device 200 of FIGS. 2 to 4, the microfluidic device 700 includes a substrate 702 that has a main microfluidic channel 708, a solvent bypass channel 718, a solvent feed channel 724 that provides fluid communication between the solvent bypass channel 718 and the main microfluidic channel 708 via a first junction 726 in the main microfluidic channel 708, an oil bypass channel 728, and an oil feed channel 734 that provides fluid communication between the oil bypass channel 728 and the main microfluidic channel 708 via a second junction 736 in the main microfluidic channel. However, in the microfluidic device 700, the second junction 736 is configured such that the oil composition enters the main microfluidic channel 708 from the oil feed channel 734 as a generally continuous phase, and such that fluids already in the main microfluidic channel 708 (e.g. the isolation fluid and/or solvent) form slugs in the oil composition. In other words, in the second junction 736 of microfluidic device 700, the T of the T-junction is inverted as compared to the second junction 236 of microfluidic device 200.

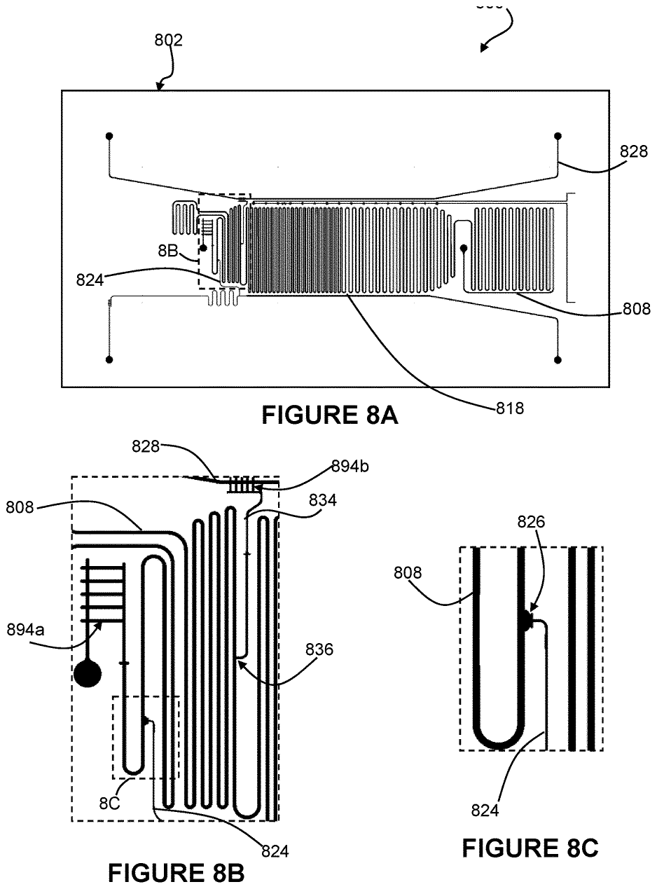

Referring now to FIGS. 8A to 8C, a further example of a microfluidic device is shown. Features in FIGS. 8A to 8C that are like those of FIGS. 2 to 4 will be referred to with like reference numerals as in FIGS. 2 to 4, incremented by 600. The microfluidic device 800 of FIGS. 8A to 8C may be used in the system 500 of FIG. 5, or in other systems. The microfluidic device 800 may be used according to the methods described above and shown in FIG. 6, or according to other methods.

Similarly to the microfluidic device 200 of FIGS. 2 to 4, the microfluidic device 800 includes a substrate 802 that has a main microfluidic channel 808, a solvent bypass channel 818, a solvent feed channel 824 that provides fluid communication between the solvent bypass channel 818 and the main microfluidic channel 808 via a first junction 826 (labelled in FIG. 8C) in the main microfluidic channel 808, an oil bypass channel 828, and an oil feed channel 834 (labelled in FIG. 8B) that provides fluid communication between the oil bypass channel 828 and the main microfluidic channel 808 via a second junction 836 (labelled in FIG. 8B) in the main microfluidic channel.

In the microfluidic device 800, the main microfluidic channel 808 is longer than the microfluidic channel 208 (and thus includes more windings). This can allow for more compound slugs in the main microfluidic channel 808 at any given time, which can in turn provide a larger amount of data points at east subsequent pressure.

Furthermore, as can be seen in FIG. 8B, the microfluidic device 800 includes two filter zones (i.e. the main microfluidic channel includes a first filter zone 894a, and the oil feed channel includes a second filter zone 894b). Each filter zone 894a, 894b includes a set of channels that run in parallel and that have a relatively small cross-section (e.g. a depth of 1 to 5 microns and a width of 50 microns). If a relatively large particle were to plug one of the channels of the filter zone 894a or 894b, fluid could continue to flow through the remaining channels. The filter zones can prevent plugging of the microfluidic device 800 (or can minimize or reduce the risk thereof).

Furthermore, as can be seen in FIG. 8C, the main microfluidic channel 808 includes an enlargement at the first junction 826. The enlargement allows for the presence of a relatively large volume of isolation fluid at the first junction 826. This can in turn result in a larger spacing between the compound slugs.

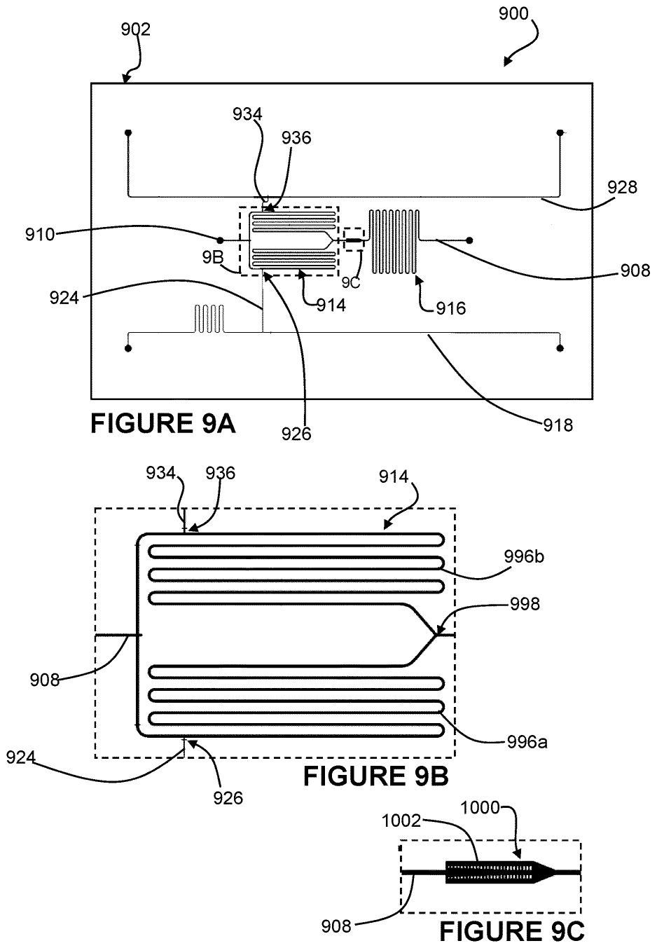

Referring now to FIGS. 9A to 9C, a further example of a microfluidic device is shown. Features in FIGS. 9A to 9C that are like those of FIGS. 2 to 4 will be referred to with like reference numerals as in FIGS. 2 to 4, incremented by 700. The microfluidic device 900 of FIGS. 9A to 9C may be used in the system 500 of FIG. 5, or in other systems. The microfluidic device 900 may be used according to the methods described above and shown in FIG. 6, or according to other methods.

Similarly to the microfluidic device 200 of FIGS. 2 to 4, the microfluidic device 900 includes a substrate 902 that has a main microfluidic channel 908, a solvent bypass channel 918, a solvent feed channel 924 that provides fluid communication between the solvent bypass channel 918 and the main microfluidic channel 908 via a first junction 926 in the main microfluidic channel 908, an oil bypass channel 928, and an oil feed channel 934 that provides fluid communication between the oil bypass channel 928 and the main microfluidic channel 908 via a second junction 936 in the main microfluidic channel. However, in the microfluidic device 900, the main microfluidic channel 908 is branched. That is, in the example shown, the main microfluidic channel 908 includes a first section 914 downstream of the main inlet port 910 and a second section 916 downstream of the first section 916. As shown in FIG. 9B, the first section 914 branches into a first branch 996a and a second branch 996b. The first junction 926 is in the first branch 996a, and the second junction 936 is in the second branch 996b. The first branch 996a and second branch 996b are in parallel and join at a third junction 998. This branching allows for slugs of solvent in the isolation fluid and slugs of oil composition in the isolation fluid to form separately (in the first branch 996a and second branch 996b, respectively), and for the slugs to then merge into compound slugs at or downstream of the third junction 998. In particular, one or more slugs of the solvent in the isolation fluid can be formed in the first branch 996a of the main microfluidic channel 908, and or more slugs of the oil composition in the isolation fluid can be formed in the second branch 996b of the main microfluidic channel 908. Then, the slug(s) of the solvent and the slug(s) of the oil composition can be combined at or downstream of the third junction 998, to yield the compound slug(s).

Furthermore, referring to FIG. 9C, in the microfluidic device 900, the main microfluidic channel 908 includes a third section 1000 that is between the third junction 998 (shown in FIG. 9B) and the second section 916 (shown in FIG. 9A). The third section 1000 includes a micropillar array 1002. In use, the slug(s) of oil composition and the slug(s) of solvent can flow into the micropillar array 1002, and the micropillar array 1002 can facilitate compound slug formation by increasing the contact between the slug(s) of solvent and the slug(s) of oil composition, and by slowing down flow.

In any of the above examples, the oil composition can be created on the microfluidic chip, prior to entering the main microfluidic channel. For example, an oil (e.g. a dead oil) and a gas can be combined on the microfluidic chip, to yield a slug of the oil composition in the form of a live oil.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

1. A method for assessing interaction between an oil composition and a solvent, the method comprising:
a. within a microfluidic channel, isolating at least a first compound slug in an isolation fluid, wherein the first compound slug comprises at least a first slug of an oil composition in contact with at least a first slug of a solvent; and
b. with the first compound slug isolated in the isolation fluid and within the microfluidic channel, and while maintaining the microfluidic channel at a first test temperature and a first test pressure, conducting an optical investigation of at least the first compound slug to assess interaction between the oil composition and the solvent at the first test pressure and first test temperature.

2. The method of claim 1, wherein step b. is carried out while the first compound slug is maintained generally stationary within the microfluidic channel.

3. The method of claim 1, wherein step b. comprises assessing a liquid phase volume and a gas phase volume for at least the first compound slug, and/or wherein the method further comprises assessing a ratio of the solvent to the oil composition for at least the first compound slug prior to step b.

4. (canceled)

5. The method of claim 1, wherein the first compound slug is one of a plurality of compound slugs;
step a. comprises isolating each compound slug in the isolation fluid and within the microfluidic channel;
prior to step b., and with each compound slug isolated in the isolation fluid and within the microfluidic channel, the method further comprises assessing a respective ratio of the solvent to the oil composition for each compound slug; and
step b. comprises conducting an optical investigation of each compound slug to assess the interaction between the oil composition and the solvent at the first test pressure and first test temperature.

6. (canceled)

7. The method of claim 1 further comprising:
c. adjusting the microfluidic channel to a subsequent test pressure; and
d. after step c., and while maintaining the first compound slug at the subsequent test pressure, conducting another optical investigation of at least the first compound slug to assess interaction between the oil composition and the solvent at the subsequent test pressure;
wherein steps b. and c. comprise using the isolation fluid as a piston fluid to maintain the microfluidic channel at the first test pressure and to adjust the microfluidic channel to the subsequent test pressure, and
wherein throughout steps b., c., and d., the first compound slug is maintained generally stationary within the microfluidic channel.

8. (canceled)

9. (canceled)

10. The method of claim 7, further comprising:
e. serially repeating steps c. and d. with further subsequent test pressures until the first compound slug is of a single phase.

11. The method of claim 7, further comprising:
e. serially repeating steps c. and d. with further subsequent test pressures to assess a saturation pressure for the oil composition and the solvent at the mole ratio and at the first test temperature, and/or to assess an oil swelling factor for the oil composition and the solvent at the first test temperature, and/or to assess at least one of a diffusivity and a solubility of the solvent in the oil composition and at the first test temperature, and/or to assess a first contact minimum miscibility pressure for the solvent and the oil composition and at the first test temperature.

12. (canceled)

13. (canceled)

14. (canceled)

15. The method of claim 1, further comprising, prior to step a.:
within the microfluidic channel, combining an oil and a gas to yield the first slug of the oil composition.

16. The method of claim 1 wherein step a. comprises:
i. flowing the solvent into the microfluidic channel to fill the microfluidic channel with the solvent;
ii. while continuing to flow the solvent into the microfluidic channel, flowing the isolation fluid into the microfluidic channel, to form at least the first slug of the solvent in the isolation fluid; and
iii. while continuing to flow the solvent and the isolation fluid into the microfluidic channel, flowing the oil composition into the microfluidic channel, to form at least the first slug of the oil composition in the isolation fluid and yield the first compound slug.

17. The method of claim 1, wherein step a. comprises:
i. in a first branch of the microfluidic channel, forming at least the first slug of the solvent in the isolation fluid;
ii. in a second branch of the microfluidic channel, forming at least the first slug of the oil composition in the isolation fluid; and
iii. after steps i., and ii., combining the first slug of the solvent and the first slug of the oil composition to yield the first compound slug by flowing the first slug of the oil composition and the first slug of the solvent into a micropillar array of the microfluidic channel.

18. (canceled)

19. A microfluidic device comprising:
a microfluidic substrate comprising
a main inlet port, a main outlet port, and a main microfluidic channel extending between and in fluid communication with the main inlet port and the main outlet port;
a solvent inlet port, a solvent outlet port, and a solvent bypass channel extending between and in fluid communication with the solvent inlet port and the solvent outlet port;
a solvent feed channel extending between and in fluid communication with the solvent bypass channel and the main microfluidic channel, wherein the solvent feed channel is joined to the main microfluidic channel at a first junction,
an oil inlet port, an oil outlet port, and an oil bypass channel extending between and in fluid communication with the oil inlet port and the oil outlet port; and
an oil feed channel extending between and in fluid communication with the oil bypass channel and the main microfluidic channel, wherein the oil feed channel is joined to the main microfluidic channel at a second junction, wherein the second junction is spaced from the first junction.

20. The microfluidic device of claim 19, wherein
the first junction is in a first section of the main microfluidic channel, and the second junction is in a second section of the main microfluidic channel that is downstream of the first section; and
at least one of the first junction and the second junction is a T-junction.

21. (canceled)

22. The microfluidic device of claim 19 wherein the oil feed channel comprises a filter zone, and/or wherein the main microfluidic channel comprises an enlargement at the first junction.

23. (canceled)

24. The microfluidic device of claim 19, wherein the main microfluidic channel comprises:
a first section downstream of the main inlet, wherein the first section branches into a first branch and a second branch that are in parallel and that join at a third junction; and
a second section downstream of the third junction;
wherein the first junction is in the first branch and the second junction is in the second branch.

25. (canceled)

26. The microfluidic device of claim 24, wherein the main microfluidic channel further comprises a third section between the third junction and the second section, wherein the third section comprises a micropillar array.

27. The microfluidic device of claim 19, wherein the solvent inlet port and the oil inlet port are in fluid communication only via the main microfluidic channel.

28. A microfluidic system comprising:
a microfluidic device comprising a microfluidic substrate, the microfluidic substrate comprising a main microfluidic channel;
an isolation fluid injection sub-system housing an isolation fluid and configured to force the isolation fluid into the main microfluidic channel;
a solvent injection sub-system housing a solvent and configured to force the solvent into the main microfluidic channel concurrently with the isolation fluid to form at least a first slug of the solvent in the isolation fluid and within main microfluidic channel;
an oil composition injection sub-system housing the oil composition and configured to force the oil composition into the main microfluidic channel concurrently with the isolation fluid and the solvent, to form at least a first compound slug in the isolation fluid and within the main microfluidic channel, wherein the first compound slug comprises at least a first slug of the oil composition in contact with the first slug of the solvent;
a pressure regulation sub-system for regulating pressure in the main microfluidic channel;
a manifold providing fluid communication between the microfluidic device and the solvent injection sub-system, the isolation fluid injection sub-system, the oil composition injection sub-system, and the pressure regulation sub-system;
a temperature regulation sub-system for regulating a temperature within the main microfluidic channel; and
an optical investigation sub-system for optically accessing at least a portion of the main microfluidic channel for assessment of at least the first compound slug.

29. The microfluidic system of claim 28, wherein the microfluidic substrate further comprises:
a main inlet port that is in fluid communication with the isolation fluid injection system via the manifold, and a main outlet port that is in fluid communication with the pressure regulation system via the manifold, wherein the main microfluidic channel extends between and is in fluid communication with the main inlet port and the main outlet port;
a solvent inlet port that is in fluid communication with the solvent injection system via the manifold;
a solvent outlet port that is in fluid communication with the pressure regulation system via the manifold;
a solvent bypass channel extending between and in fluid communication with the solvent inlet port and the solvent outlet port;
a solvent feed channel extending between and in fluid communication with the solvent bypass channel and the main microfluidic channel;
an oil inlet port that is in fluid communication with the oil composition injection system via the manifold;
an oil outlet port that is in fluid communication with the pressure regulation system via the manifold;
an oil bypass channel extending between and in fluid communication with the oil inlet port and the oil outlet port; and
an oil feed channel extending between and in fluid communication with the oil bypass channel and the main microfluidic channel.

30. (canceled)

31. (canceled)

32. The microfluidic system of claim 28, wherein the pressure regulation sub-system comprises a back pressure pump in fluid communication with the main outlet port, the solvent outlet port, and the oil outlet port via the manifold.

33. The microfluidic system of claim 32,
wherein the pressure regulation sub-system further comprises a pressure bypass line system providing fluid communication between the isolation fluid injection sub-system and the main outlet port external to the microfluidic device, whereby the isolation fluid is forceable through the pressure bypass line system to pressurize the main microfluidic channel; and
wherein the pressure bypass line system further provides fluid communication between the isolation fluid injection sub-system and the oil inlet port, external to the microfluidic device, and/or further provides fluid communication between the isolation fluid injection sub-system and the solvent outlet port, external to the microfluidic device, and/or further provides fluid communication between the isolation fluid injection sub-system and the oil outlet port, external to the microfluidic device.

34. (canceled)

35. (canceled)

36. (canceled)
